(19) United States
(12) Patent Application Publication
(10) Pub. No.: US 2008/0262664 A1
(43) Pub. Date: Oct. 23, 2008

(54) Synthetic vision system and methods

(76) Inventors: Thomas Schnell, Iowa City, IA (US); Jason C. Wenger, North Liberty, IA (US); Alexei Postnikov, Cedar Rapids, IA (US)

Correspondence Address: VALAUSKAS & PINE LLC, Suite 1825, 150 North Wacker Drive, Chicago, IL, 60606, US

(21) Appl. No.: 11/881,409

(22) Filed: Jul. 25, 2007

Related U.S. Application Data
(60) Provisional application No. 60/833,171, filed on Jul. 25, 2006.

(51) Int. Cl. G06F 19/00; G08B 21/00

(52) U.S. Cl. 701/4; 701/3; 340/945

(57) ABSTRACT

The present invention is directed to a system and methods, embodiments of which provide increased situation awareness information in an improved Synthetic Vision System (SVS). According to the present invention, a Primary Flight Display (PFD), a top-down view Multi-Function Display (MFD), and side-view Vertical Profile Display (VPD) are presented on one user interface with an input device, such as a transparent touch screen for quick and easy data entry. The present invention also provides color shading, such as red, to communicate areas where the aircraft may be in conflict with terrain or obstacles at a point in time in the future.

This application claims the benefit of U.S. Provisional Application No. 60/833,171 filed Jul. 25, 2006.

### FIELD OF THE INVENTION

The present invention generally relates to a system and methods for improved synthetic vision. More specifically, the present invention is directed to a system and methods of increased situation awareness information.

### BACKGROUND OF THE INVENTION

A Synthetic Vision System (“SVS”) provides pilots with clear and intuitive means of understanding their flying environment. SVS seeks to offer a realistic three-dimensional (3D) image of the terrain in front of the aircraft, in order to increase pilot awareness of the upcoming and surrounding terrain and thereby reduce the likelihood of Controlled Flight Into Terrain (“CFIT”) accidents. CFIT accidents are those in which an aircraft that is airworthy and is under pilot control, inadvertently flies into terrain, an obstacle, or water.

CFIT accidents remain a leading cause for loss of hull and life in General Aviation. General Aviation (“GA”) includes both commercial and non-commercial aviation, such as private flying, flight training, air charter, bush flying, gliding, and many others.

The 2002 Nall Report indicates that most weather-related accidents involved aircraft striking objects or terrain at high airspeeds or crashing out of control, sometimes after pilot-induced structural failure. Also, flight at night can lead to more severe crashes. One of the leading causes of accidents is a lack of situation awareness information in conditions of reduced visibility.

A typical SVS utilizes certain components that are known collectively as the Primary Flight Display (“PFD”), a set of indicators stored on board the aircraft; an image generator computer; and, a display. The PFD provides flight information. The display layout of a PFD can vary depending on the aircraft, the aircraft's manufacturer, the specific model of PFD, certain settings chosen by the pilot, and various internal options that are selected by the owner of the aircraft.

However, the PFD usually contains an attitude indicator, which gives the pilot information about the aircraft's pitch and roll characteristics, and the orientation of the aircraft with respect to the horizon as well as the aircraft's altitude above sea level. The PFD also typically includes a depiction of the aircraft's future path (over the next few seconds), along with an airspeed indicator, which displays the speed of the aircraft in knots. The vertical speed indicator, usually positioned adjacent to the altitude indicator, identifies how fast the aircraft is ascending or descending, or the rate at which the altitude changes. Usually positioned in a lower portion of the PFD is the heading display, which shows the pilot the magnetic heading of the aircraft. The great variability in the precise details of PFD layout makes it necessary for pilots to study the specific PFD of the specific aircraft they will be flying in advance, so that they know exactly where and how certain data are presented.

While the basics of flight parameters such as speed, altitude, and attitude tend to be much the same in all PFDs, much of the other useful information presented on the display is shown through different formats on different PFDs. For example, one PFD may show what is known as “the current angle of attack” as a tiny dial near the attitude indicator, while another PFD may actually superimpose this information on the attitude indicator. Since the various graphic features of the PFD are not labeled, the pilot must learn what each means in advance. Additionally, these SVSs are expensive.

Not only are various Synthetic Vision Systems expensive, and therefore costly to replace if the aircraft pilot finds the displays to difficult to read, but current SVSs have many problems associated with them. One common problem with some SVSs it that the illustrated pathway is a fixed, earth-referenced path that climbs from the airport to a designated altitude and then back down to the destination airport. Such a fixed vertical path alignment makes it largely impossible to foresee the climb capability of an aircraft under different conditions such as different winds, temperatures, engine performance, and aircraft loading. Thus, a fixed ascending path may exceed the climb performance of an aircraft, and thereby cause the pilot to fly into a stall condition, a highly dangerous situation. A fixed descending path may lead a pilot to permit the aircraft to become too fast in the descent. Furthermore, SVSs and traditional Electronic Flight Information Systems (EFISs) do not provide pitch ladder symbologies that emphasize extreme deviations from level flight in a visually intuitive form. SVSs and EFISs do not have a perspective, top-down, and side profile view consolidated on the same display. Because of this shortcoming, the pilot must fixate separate displays to assimilate this type of information.

Overall, while current SVSs provide pilots with information of the contemporary as well as predictions regarding the future state of the aircraft with respect to the terrain, including towers, buildings and other environment features, a vast majority of current GA aircraft do not include tools that provide integrated terrain, obstacle, and pathway situation awareness, let alone in a perspective, top-down, and side profile view display configuration.

There is a demand for an improved SVS that provides situation awareness information by which CFIT accidents may be more drastically reduced. The present invention satisfies this demand.

### SUMMARY OF THE INVENTION

The present invention is an improved SVS that provides increased situation awareness information. For purposes of this application, situation awareness information is that information and data that relates to three dimensional recognition of terrain conflicts, obstacle conflicts, flight path and trajectory, location and orientation of navigation aids, and maintenance of spatial orientation. For purposes of this application, the term “terrain conflicts” includes the third or vertical dimension of land surface, for example, land formations and bodies of water. “Obstacle conflicts” includes any physical impediment, for example, manmade obstructions, towers and buildings. The term pathway, or flight path, means the course, route, or way of the aircraft in three dimensions. Navigation aid, or Navaid, is any sort of marker which aids in navigation, for example a Very High Frequency Omni-bearing Range (“VOR”), Global Position System (“GPS”) waypoint, airway intersection, airport, etc.

Overall the term “flight performance” is information regarding aircraft parameters so that requirements of the government certifying agency are met. In the U.S., the government certifying agency is the Federal Aviation Administration (FAA). In other countries, the government certifying agency is as follows: Canada-Transport Canada (TC); the United Kingdom (UK)—the Civil Aviation Authority, and, the European Union—the Joint Aviation Authorities (JAA). Aircraft parameters include temperatures, pressures, airspeed, altitude, attitude, aircraft controls positions (stick/yoke position, rudder pedal position, and throttle position), engine performance, and atmospheric conditions.

An object of the present invention is to provide more robust situation awareness information to reduce Controlled Flight Into Terrain (CFIT) accidents.

Another object of the present invention is to provide an improved SVS for use primarily in the field of General Aviation (GA), although it is anticipated that the preset invention may be advantageous to certain commercial operators, including Emergency Medical Service (EMS) helicopter operators.

An object of the present invention is to provide a portable, low-cost improved SVS that seeks to enhance pilot awareness of surrounding terrain, obstacles, pathway, navigation aids, and selected flight performance data in a single, self contained user interface for use in an operational environment.

Yet another object of the present invention is to provide a user interface with a display that simultaneously illustrates the aircraft situation in a perspective, top-down, and side profile view. The user interface preferably is a compact and portable component, such as a computer. The user interface also includes an input device, preferably a keyboard or touch screen, used to input data. Simultaneously providing a perspective, top-down, and side profile view on a single display of a user interface facilitates ease of situation awareness information assimilation. The Primary Flight Display, or “PFD”, provides a perspective view, a Multi-Function Display (“MFD”) or Navigation Display (“ND”) provides at top-down view, and a Vertical Profile Display (“VPD”) provides a side profile view. It is also contemplated that additional information can be simultaneously illustrated on the display of the user interface, for example, flight planning data and menus.

Another object of the present invention is to provide a user interface with an input device for data entry. Such a device preferably includes a touch screen with touch fields, toggle buttons and icon elements, or others. Touch screen data entry involves the selection of an icon element from a plurality of icon elements, or text entry, for example, Navaids, navigation points in and around water, and airports, as well as numbers such as climb/descent clearance limits, headings, or speeds to fly. The present invention may use icon elements on the touch screen rather than other traditional known methods, for example, a stylus, or stylus entry. A stylus could accidentally be dropped, which could potentially cause the pilot to lose control of the aircraft in an attempt to pick up the stylus from the floor.

Another object of the present invention is to provide a touch screen one embodiment of which the input device, such as a keypad, is transparent or semi-transparent. A transparent or semi-transparent input device is advantageous in that it can be positioned over the MFD. It is also contemplated that the transparent or semi-transparent input device may be positioned over the PFD or VPD. A transparent or semi-transparent input device avoids visual obstruction of the MFD while entering data on the touch screen. In addition, the touch fields, toggle buttons or icon elements of the touch screen may be large for ease of selection.

Yet another object of the present invention is to provide touch screen data entry that facilitates the use of unique Short Message Service (“SMS”) letter entry. Unlike telephone SMS style entry in which a numerical button must be pressed multiple times for a desired letter (for example, pressing the number 2 twice produces the letter “b”), a numerical button needs to be pushed only once to select a letter. The numerical code entered by selecting the numerical buttons that are associated with letters generates a unique identifier such as, for example, Navaids, waypoints, or airports. If the numerical code does not generate a unique Navaid or airport identifier, a database is searched for all possible matches and presents a picklist that is sorted, for example, in ascending distance for Navaids, waypoints, and airports from the current position of the aircraft. Entering a Navaid, waypoint, and/or airport during aircraft operation is fast and errors are minimized.

Another object of the present invention is to provide a modular SVS that can function on a distributed network of computers for certified versions for non-portable, panel-mounted applications.

Another object of the present invention is to provide a system that provides synthetically generated depiction of the terrain and obstacles surrounding the aircraft.

Another object of the present invention is to provide a supplementary system as a backup to existing equipment in the event of an electrical failure. An embodiment of the present invention includes a battery that permits uninterrupted use for a duration of time, for example, one hour, subsequent to an electrical failure.

Another object of the present invention is to use a graphics engine in generating a vertical terrain profile, or terrain side profile view. Current SVSs use general purpose computer processing units (CPUs) for computing an elevation profile. Such CPUs are generally considered expensive from a computational stand point. The present invention utilizes a graphics engine, such as a graphical processor unit (GPU), thereby minimizing the cost of computing an elevation profile and improve display update rates.

Another object of the present invention is to provide a system that in one embodiment provides semi-transparent road-ribbon that is broken into short segments to portray the pathway. The partial transparency of the pathway facilitates recognition of terrain and obstacle features beneath the pathway. The short segments are intended to give the pilot cues for speed and proximity to the pathway.

Another object of the present invention is to provide a system that, in an additional embodiment, provides a pitch ladder and pitch arrows that are projected as if seen from the center inside a transparent sphere, with the pitch ladder degree rings corresponding to degrees of latitude on the sphere, such that the radius of the pitch ladder rings becomes smaller and smaller, the farther the aircraft deviates away from level flight, and thus visually and intuitively conveys any non-normal deviations from the straight and level flight regime. One embodiment of the improved SVS provides a pitch ladder that results from projection of lines of pitch angles onto the inside of a sphere, such that the pitch ladder bows up in a circular shape when pointing straight up, until forming a circle when pointing up, or bows down in a circular shape when pitching down, until forming a circle when pointing straight down. Such a system provides instantaneous recognition of unusual attitudes.

Another object of the present invention is to provide a system that, in an embodiment, is able to continuously render a sliver of synthetically generated terrain in the area representing the nearest horizon sky in nose-high altitudes where the perspective display field of view would normally show only blue sky, and a sliver of blue sky in the area representing the nearest horizon sky in nose-low attitudes where the perspective display field of view would normally show only synthetically generated terrain. Established design standards for conventional Electronic Flight Information Systems (“EFIS”) require that a sliver of brown for ground and blue for sky be visible at all times the aircraft is in an unusual attitude, for example, where only sky or only ground would be visible. The established standards require that a dashed horizon line separate the remaining sliver of sky or ground from its neighboring area.

Another object of the present invention is to provide a system that, in an added embodiment provides a color symbology by which information via color, such as terrain conflicts is communicated to a pilot. Most conventional SVS use red coloration for terrain that is located at or above the current altitude of the aircraft, which causes the entire PFD to turn red when landing at an airport in a mountain valley. Such liberal use of the color red may well desensitize a pilot to the hazard of terrain that really does represent a hazard to flight. The present invention determines where the terrain conflict would actually occur and colors the affected region of terrain using a warning color, such as red, in the PFD. Terrain and obstacles are shaded red in those areas where the aircraft may be in potential conflict at some point in time in the future. Warning colors are used to highlight terrain and obstacles that are dangerously close to the aircraft's projected flight path. Color symbology can also be used to highlight an icon from a plurality of icons. The highlighting can provide a pilot with a quick visual as well as communicate icons that are “alive” for selection or “dead” for no selection.

Another object of the present invention is to provide a system that in an embodiment provides a pilot with a changeable pathway climb gradient to solve problems associated with a fixed vertical path.

Another object of the present invention is to provide a system that in an embodiment provides search and confirmation function. The user interface with input device allows a pilot to easily search for information using, for example, a touch screen as well as quickly confirm a selection.

Yet another object of the present invention is to provide a system that in an embodiment allows a pilot to create a new flight plan by entering a start point and end point. An embodiment of such a system can allow a pilot to add, replace, and/or delete a waypoint (“WPT”) to the new flight plan. A waypoint is a reference point in physical space used for purposes of navigation.

Yet another object of the present invention is to provide a system that allows a pilot to add holding patterns to a flight plan. An additional embodiment of the present invention allows a pilot to change the radial and direction of the hold or accept holds as published as well as change the flight path altitude.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The present invention and its attributes and advantages will be further understood and appreciated with reference to the detailed description below of presently contemplated embodiments, taken in conjunction with the accompanying drawings.

The patent or application contains at least one drawing executed in color. Copies of this patent or application with color drawings will be provided by the Patent Office upon request and payment of the necessary fee.

FIG. 1 illustrates an on-screen display of an improved SVS according to an embodiment of the present invention;

FIG. 2 illustrates an on-screen display of the Primary Flight Display (PFD) according to an embodiment of the present invention;

FIG. 3 illustrates an on-screen display of the Multi Function Display (MFD) according to an embodiment of the present invention;

FIG. 4 illustrates an on-screen display of the Vertical Profile Display (VPD) according to an embodiment of the present invention;

FIG. 5 illustrates an on-screen display of the Information Window (IW) according to an embodiment of the present invention;

FIG. 6 illustrates an on-screen display of an icon-based main menu according to an embodiment of the present invention;

FIG. 7 illustrates an on-screen display of an icon-based submenu o according to an embodiment of the present invention;

FIG. 8 illustrates an on-screen display of display options of the MFD according to an embodiment of the present invention;

FIG. 9 illustrates an on-screen display of a touch screen input device according to an embodiment of the present invention;

FIG. 10 illustrates an on-screen display of the search menu according to an embodiment of the present invention;

FIG. 11 is a flow chart of data entry methodology according to an embodiment of the present invention;

FIG. 12 illustrates an on-screen display of a semi-transparent road-ribbon on the PFD according to an embodiment of the present invention;

FIG. 13 illustrates an on-screen display of the unusual altitudes according to an embodiment of the present invention;

FIG. 14 illustrates another embodiment of an on-screen display of unusual altitudes according to an embodiment of the present invention;

FIG. 15 illustrates an on-screen display of a terrain conflict warning according to an embodiment of the present invention;

FIG. 16 illustrates an on-screen display of a user changeable climb gradient according to an embodiment of the present invention; and

FIG. 17 illustrates an on-screen display of ground indicators according to an embodiment of the present invention.

### DETAILED DESCRIPTION OF EMBODIMENTS OF THE INVENTION

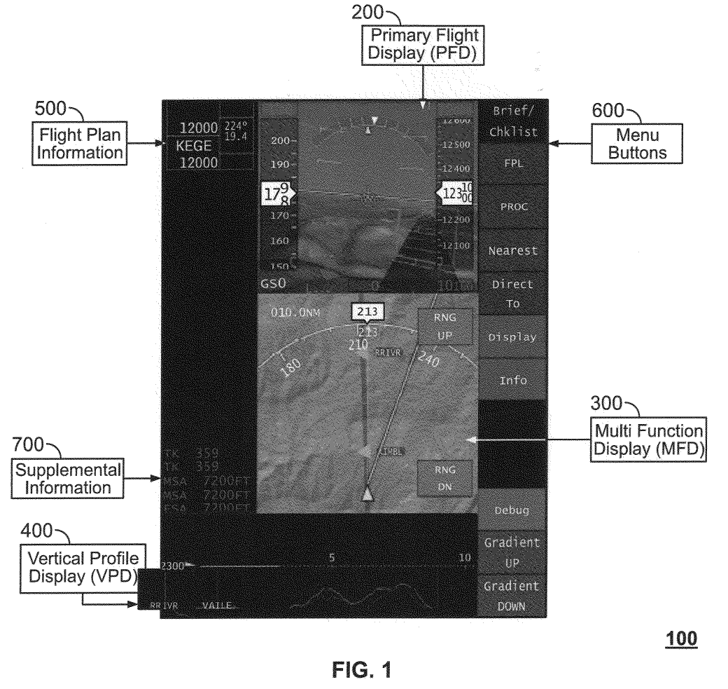

An improved Synthetic Vision System (“SVS”) according to the present invention is identified in the following as “100”. An embodiment of the present invention is shown in FIG. 1 and includes a perspective view of Primary Flight Display (“PFD”) 200, a top-down view Multi-Function Display (“MFD”) 300, otherwise referred to herein as Navigation Display (“ND”) 300, and a side-view Vertical Profile Display (“VPD”) 400 consolidated on one user interface with an input device, for example, a touch-screen display, otherwise referred to herein as display. The improved SVS 100 may include also an icon-based menu 600, flight plan information 500 and, an information window 700 that includes supplemental information.

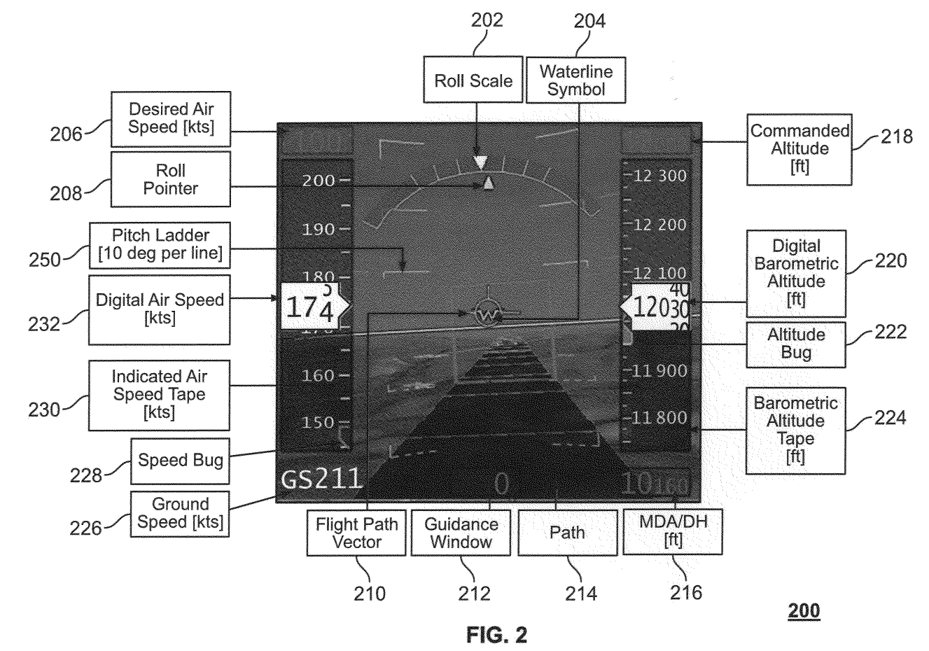

As illustrated in more detail in FIG. 2, an embodiment of the improved SVS according to the present invention can include a PFD 200 which includes parameters such as a roll scale 202, waterline symbol 204, altitude, speed 206, roll pointer 208, flight path vector 210, guidance window 212 and pitch latter 250, or other components. The PFD 200 may provide a pilot with a great variety of information. Such information may be provided through an attitude indicator that illustrates blue sky over brown terrain. Such a PFD image 200 may move to indicate the pitch and roll of the aircraft. A pathway 214 seen as the brown ribbon at the bottom of the screen seeks to guide the pilot along their flight plan. Overall, guidance is provided by a flight path vector 210 is to be positioned in the center of the magenta guidance window 212. As is standard among glass cockpit displays, airspeed can be seen at the left, while altitude is at the right of the PFD image 200. The airspeed tape 230 may be color coded, matching with the standard arcs seen on a traditional round airspeed indicator.

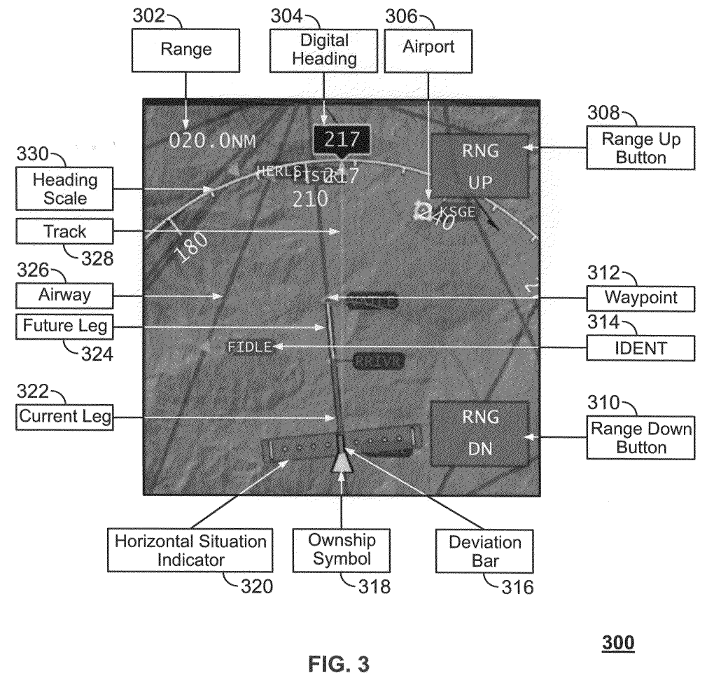

An embodiment of the improved SVS 100 may further include a Multi Function Display (“MFD”) 300 as shown in FIG. 3. The MFD 300 includes information such as range 302, heading 304, airport 306, waypoint 312, airway 326, leg 324, track 328 and scale 330 to name a few. Range 302 refers to the distance in the real world that is depicted on the MFD image 300 from the aircraft symbol to the top edge of the MFD image 300 where the terrain depiction ends. Heading 300 is the direction in which the aircraft points. Airways 326 refer to flight routes specified on government issued flight charts. A leg 322 is a segment of a flight plan that connects two waypoints 312. The MFD image 300 may display a moving map to the pilot, and may include a view of terrain, nearby obstacles, the current path, navaids, and weather. It also may provide a Horizontal Situation Indicator (“HIS”) 320 to display more accurate guidance information to the pilot when they are far from their path. The MFD 300 seeks to allow a pilot to accurately fly headings, as is often required during maneuvering under the control of Air Traffic Control. Following standard conventions, the current leg 322 of a route is illustrated in magenta, while future legs 324 are illustrated in white although any colors are contemplated. Airspace boundaries are also displayed, increasingly important in modern aviation, where blundering into a controlled airspace may have serious consequences. Airspace around airports is shown as a pair of concentric circles.

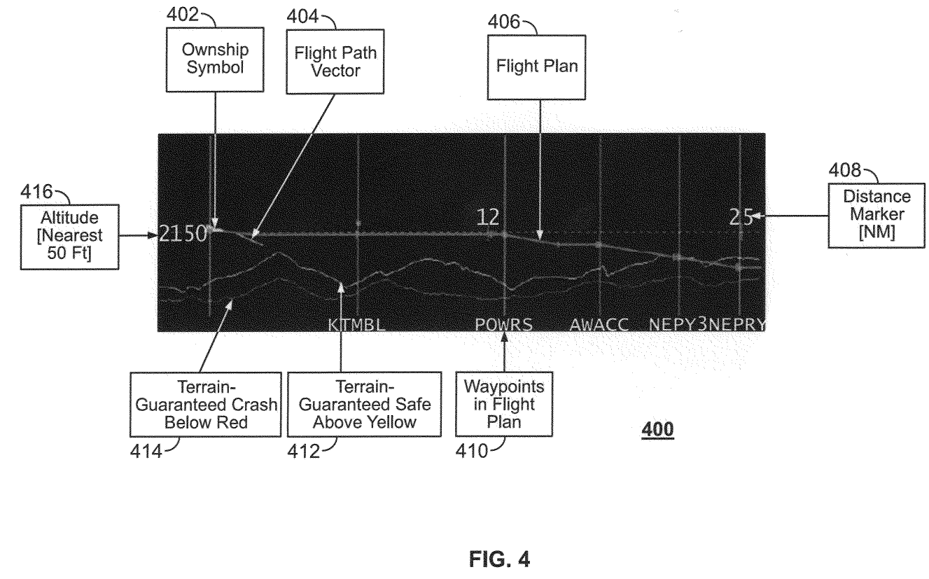

An embodiment of the Vertical Profile Display (“VPD”) 400 of the improved SVS is shown in FIG. 4. The VPD 400 illustrates a side view of the terrain in the direction of the aircraft's flight. Parameters of the VPD include, for example, ownship symbol 402, flight path vector 404, flight plan 406, distance marker 408, waypoints in flight plan 410, altitude 416 and terrain location 414.

It may also present a depiction of the route, allowing the pilot to judge whether altitudes chosen for future segments are appropriate for terrain avoidance. The VPD image 400 also allows for good estimation of distance required to complete a climb, as well as distance to terrain features in front of the aircraft. Terrain that is shaded red is above the aircraft. Terrain that is shaded yellow is 0 to 500 ft below the aircraft.

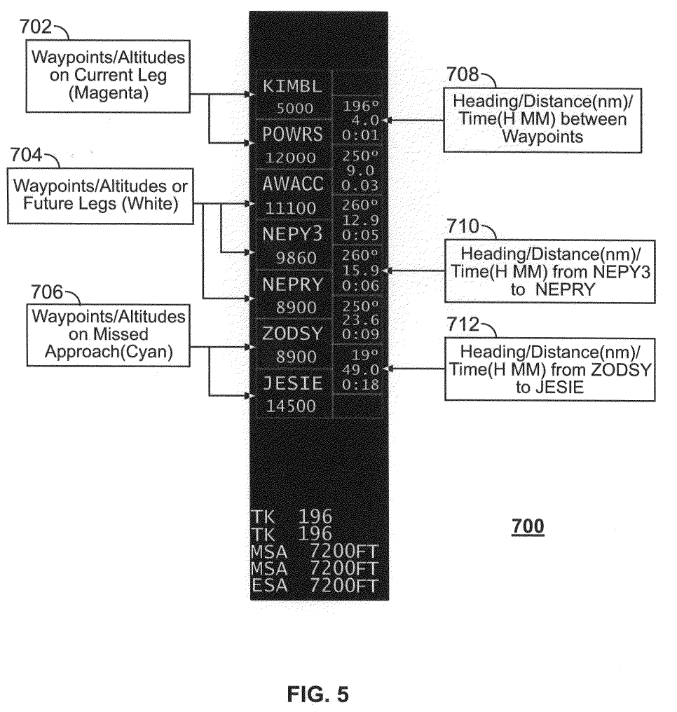

As shown in FIG. 5, the improved SVS 100 may further include an Information Window (IW) 700. The IW image 700 may provide waypoints and altitudes on the current leg 702, for future legs 704 and on missed approaches 706. The waypoint identifier is the name of the waypoint. The altitude number below the waypoint name is the height above mean sea level at which this waypoint is being crossed. The information 708, 710, 712 to the right of the waypoint information straddles two waypoints and contains descriptive information for the leg connecting the two waypoints. The degree scale is the course of the leg in degrees. The number below that is the distance that is remaining between the airplane and the next waypoint or between two subsequent waypoints. The number below that is the cumulative time that is remaining to reach the waypoint. The IW further provides information 708, 710, 712 of the heading and distance between all waypoints, not just the next waypoint.

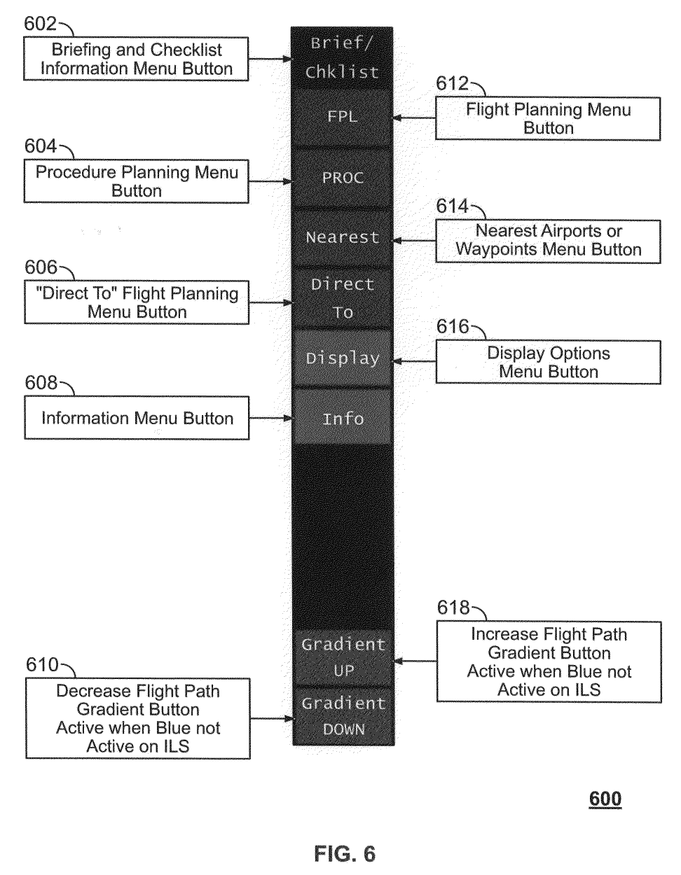

FIG. 6 illustrates an embodiment of the Main Menu 600 of the improved SVS 100. The Main Menu 600 may include various sub-menus, for example, briefing and checklist information 602, procedure planning 604, flight planning 606, nearest airports 614 and display options 616. The menus may be organized in the sequence in which a flight will occur with the ability to preview changes before accepting them and with the ability to back up to an earlier step without losing information.

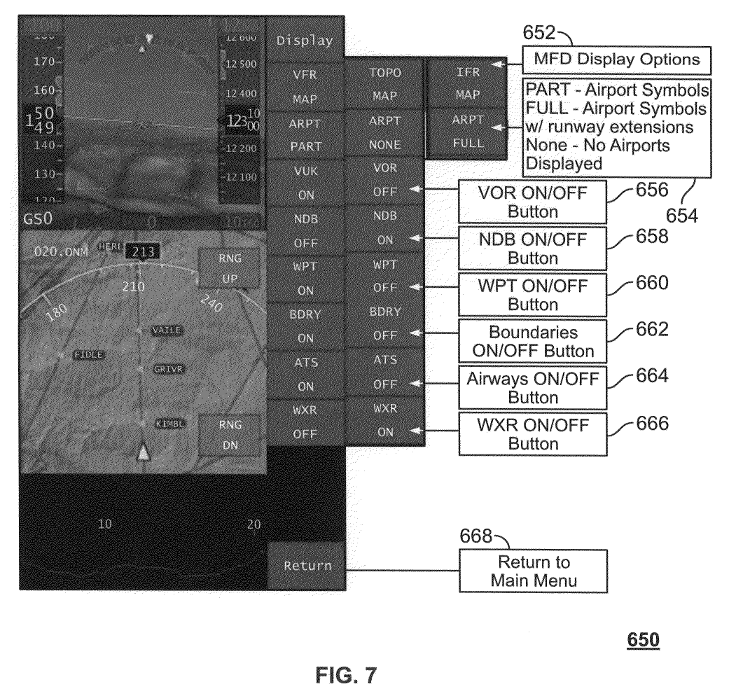

The Main Menu 600 may further include sub-menus 650, as shown in FIG. 7. For example, the Display Options sub-menu 652 of the Main Menu 600 may include ON/OFF toggle buttons, or icons for navigation aids 656, 658, 660, airspace boundaries 662, airways 664, airports 654, and data linked weather 666. If the pilot turns off one of these toggle buttons, an abbreviated annunciation with a red line through the annunciation may be shown to indicate that the toggle button is no longer shown. The button text may change the word on/off to correspond to the actual state of the annunciation. To turn a toggle button back on, the pilot can simply touch the same button again. The annunciation will be removed if a toggle button is shown, except for data linked weather information, where the age of the weather data is shown in minutes. The pilot can easily return to the Main Menu 600 from the sub-menu 650 with the Return button 668.

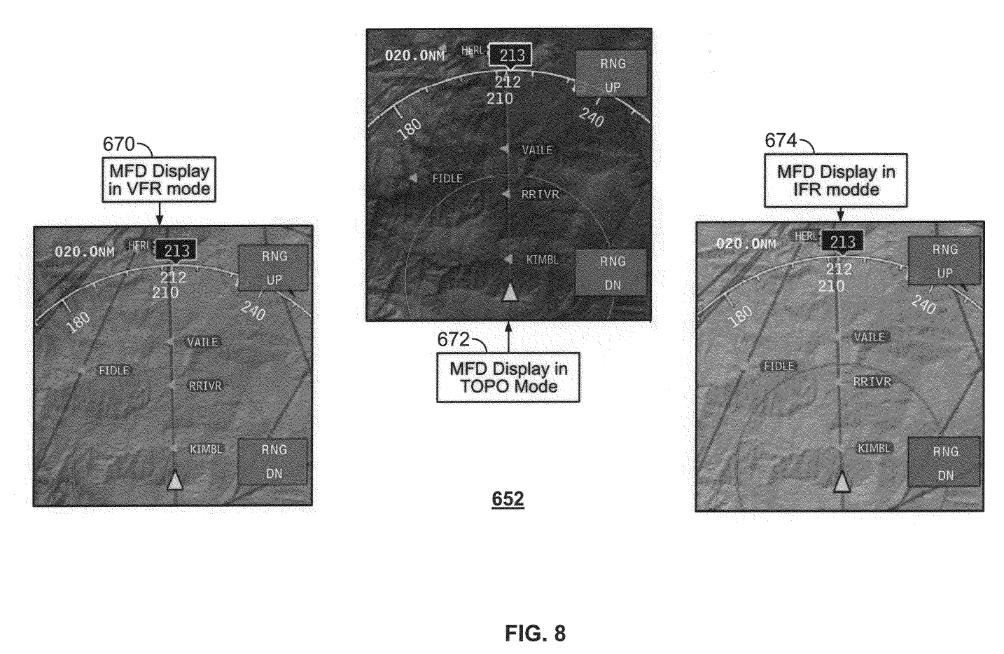

An embodiment of the Display Options 652 of the improved SVS 100 may include various modes, for example, Visual Flight Rules (“VFR”) sectional chart colors 670, topographically (“TOPO”) enhanced colors 672, and Instrument Flight Rules (“IFR”) chart colors 674, shown in FIG. 8. VFR charts may be color coded to convey altitudes such as green for low areas and brown for high areas. The MFD may be set to display the same color scheme as is found on VFR charts. The IFR color scheme eliminates clutter due to colors if the pilot is flying under positive control from air traffic control under an IFR flight plan. The TOPO mode is useful in relatively flat areas where the color scheme is more sensitive to subtle changes in terrain elevation.

The MFD may further include data linked weather surveillance. The data linked weather surveillance can be, for example, Next-Generation Radar (“NEXRAD”). NEXRAD depicts levels of precipitation intensity, for example, from green for light precipitation to red for heavy precipitation. NEXRAD is a network of high-resolution Doppler radars operated by the National Weather Service, an agency of the National Oceanic and Atmospheric Administration (“NOM”) within the United States Department of Commerce. It is contemplated that data linked weather survellience can be from any radar provider, such as WSR-1 and -1A, WSR-3, WSR-4, WSR-57, WSR-74C and -74S.

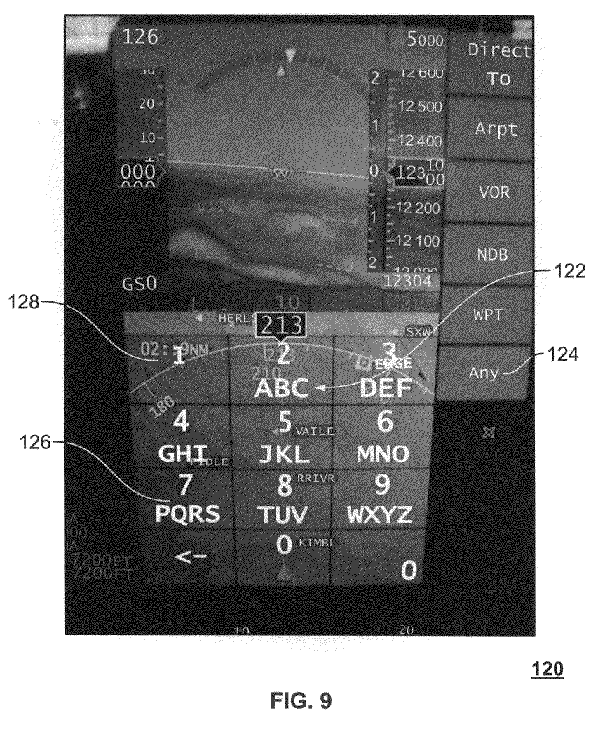

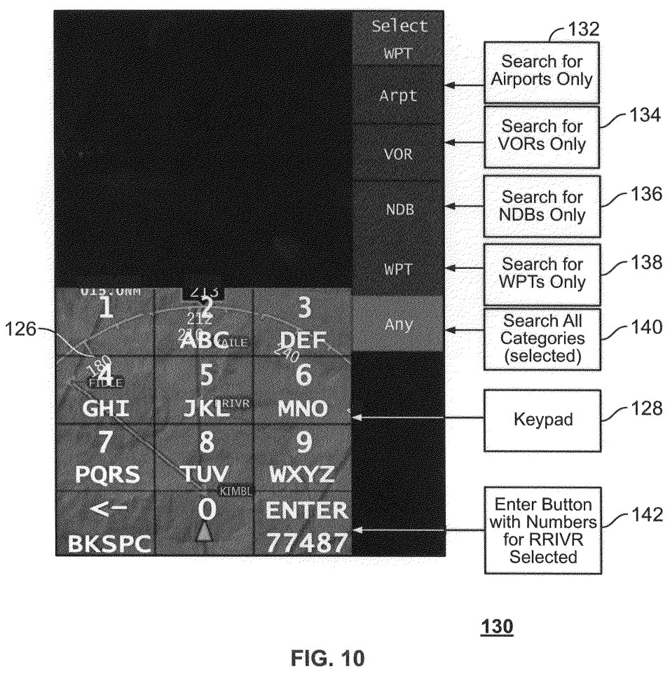

The improved SVS may further include a unique feature for data entry in addition to a search feature, as shown in FIGS. 9 and 10. A user interface 120 with an input device 122, here a touch screen 124, permits letters to be entered by touching the appropriate button 126 on a keypad 128. Unlike telephone SMS style entry, a button needs to be pushed only once to select the letter. The numerical code that is thereby generated may not represent a unique Navaid or airport identifier, thus Navaid database is searched for all possible matches and presents a picklist that is sorted in ascending distance from the current location. Thus, entering a Navaid in operational use is very fast and errors are minimized.

Additionally, certain displays can be color coded to communicate touch interactivity. For example magenta colored displays may include desired airspeed, commanded altitude, minimum descent altitude and decision height, which may be touched. When this occurs, a keypad 128 on the MFD may be used to enter a new command in these windows. These commands are displayed in the command buttons, and also set the position of the bugs on the airspeed and altitude tapes.

As shown in FIG. 10, a search menu 130 may be used to search for waypoints 138, airports 132, or other features. For example, to search for a waypoint (“WPT”) 138, the pilot selects the type or types of WPT to search for. The numbers corresponding to the letters for the WPT being searched may be entered by touching the appropriate button 126 on the keypad 128 and the enter button 142 is used to start the search. A list sorted by distance is displayed. The correct WPT can be selected from the list.

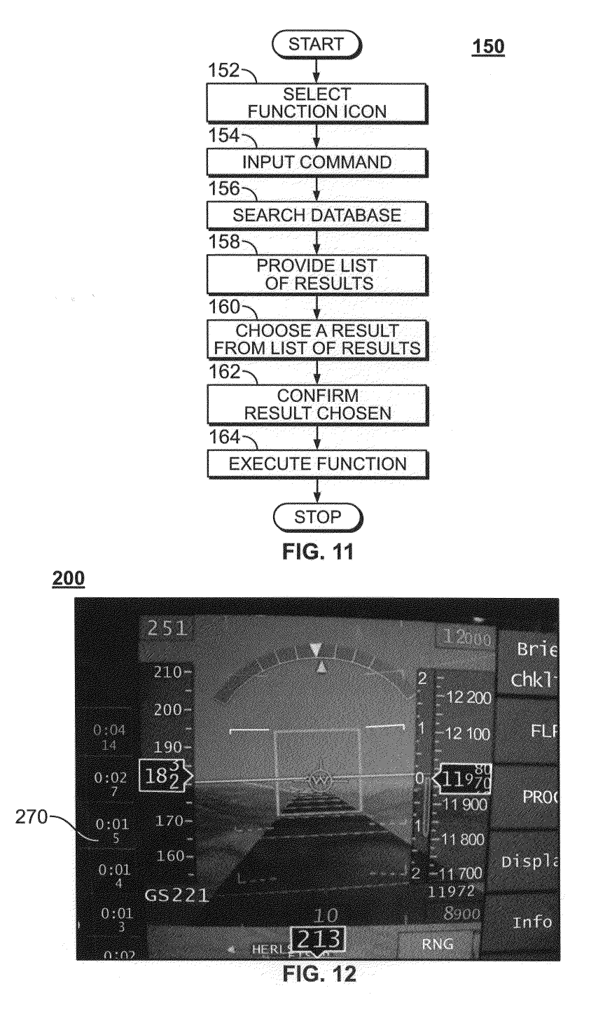

The improved SVS may allow a pilot to perform various functions using the user interface. For example, a pilot can create a new flight plan, add, delete, replace a waypoint, adding a hold, locating airports, change radial, and select an instrument approach procedure, to name a few. As shown in FIG. 11, a pilot may select an icon 152 and inputs a command 154 using the touch screen user interface of the input device. As described in more detail below, the command input may include touching button to select a letter. After the command is input at step 154, a database is searched 156. A list of results may be provided 158 and the pilot may choose a result from the list of results at step 160. The pilot then may use the touch screen to confirm the result chosen at step 162. Upon confirmation, the function is executed at step 164.

Using the methodology of FIG. 11, a pilot may create a new flight plan including selecting a starting point and selecting an ending point. The pilot may create the new flight plan by using the input device of the user interface to select icons from the main menu. Additionally, the present invention may allow a pilot to search for a starting point and an ending point, for example the type(s) of waypoints (WPT) to search for are selected and the numbers corresponding to the letters of the WPT being searched are selected and entered. The search results may be displayed. The pilot can then highlight the correct WPT from the list and confirms the selection.

The improved SVS may allow a pilot to add, delete or replace a waypoint to a flight plan. A waypoint is a reference point in physical space used for purposes of navigation. With a flight plan already entered, the icon according to the desired function (add, delete, replace waypoint) is selected from the flight plan menu.

With adding a waypoint, a category of waypoints that can be searched may be selected, for example airport, Very High Frequency Omni-bearing Range (“VOR”), Non-Directional Beacon (“NDB”), waypoint (“WPT”). The input device and search options may be used to locate a waypoint, for example, by entering the numbers corresponding to the letters of the waypoint. The pilot may then highlight the correct waypoint and confirms the selection.

With the replacement of a waypoint, the waypoint to be replaced may be first selected. Only waypoints shown in blue can be replaced, although any color is contemplated. The selection is confirmed by the pilot and the keypad and search options are used to locate a replacement waypoint. The pilot may then highlight the correct waypoint and confirms the selection.

To delete a waypoint, the waypoint to be deleted may be first selected. Only waypoints shown in blue may be replaced, although any color is contemplated. The waypoint to be deleted may be highlighted and the selection confirmed.

The proposed flight plan with the added, deleted or replaced waypoint appears in cyan on the MFD, although any color is contemplated. The pilot may then confirm the selection.

Other functions contemplated by the present invention include adding a hold to a flight plan, changing a fix, right or left turns can be selected and the radial can be changed. The holding pattern appears on the flight path on the MFD.

Additionally, the improved SVS may locate the nearest airport and/or navigation points. For example, to find the nearest airport, the “nearest airport” icon is selected. A results list displays various airports. The desired airport is highlighted and the selection is confirmed. Likewise, to find the nearest navigational point, the “nearest NAV” icon is selected. The desired navigational point is selected in the results list and the selection is confirmed.

The flight path altitude can also be reset. The flight path command altitude on the PFD is selected. The new path altitude is selected on the input device of the user interface and the Enter icon is selected to confirm the altitude.

Many methods of pathway depiction are in use in certified and research SVS. An embodiment of the present invention may provide a semi-transparent road-ribbon on the PFD 200 that may be broken into short segments to portray the pathway as shown in FIG. 12. The ribbon 270 may reduce clutter when compared to a full tunnel depiction. The ribbon 270 is like a highway in the sky and the pilot can simply follow it by staying in the middle of the ribbon and above the floor.

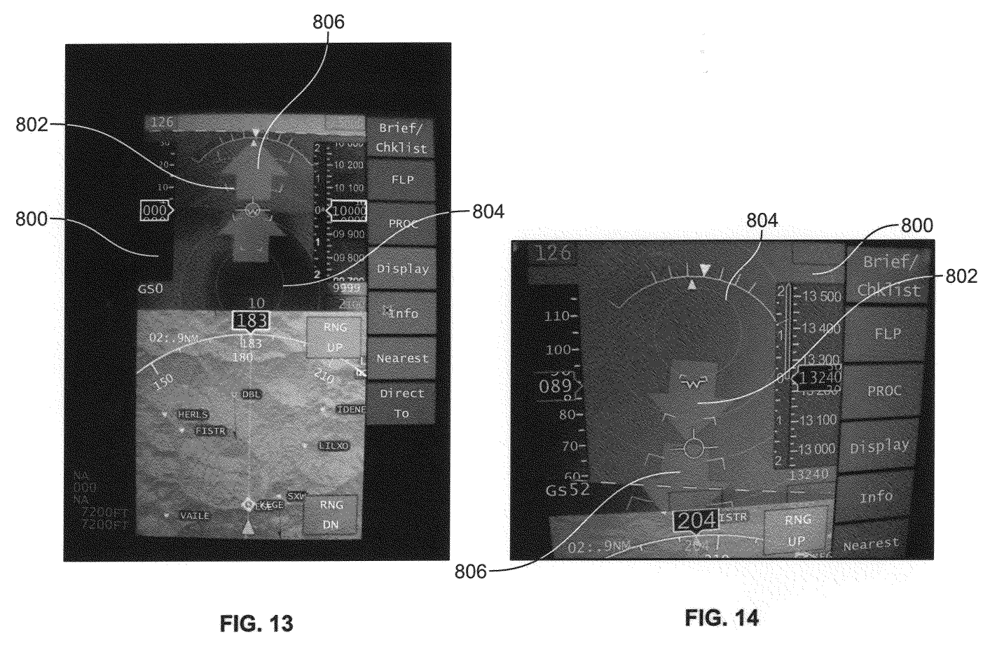

Advantageously, embodiments of the improved SVS may portray unusual attitudes, such as shown in FIGS. 13 and 14. The spherical pitch ladder 800 of the PFD 200 may consist of horizontal lines 802 that may be straight in the area around the horizon (near zero degrees of pitch) and with increasing curvature towards the extremes of positive and negative pitch excursions. The spherical pitch ladder 800 may also include circumferential rings 804 starting at the equator of the sphere and with additional rings for each increasing and decreasing 10 degrees of latitude on the transparent sphere. With the PFD camera-point located in the middle of the sphere, the pitch ladder 800 may appear as arcs as the pitch increases or decreases from the horizon and as rings 804, when approaching about plus or minus 80 degrees of pitch. In addition to the unique pitch ladder 800, pitch arrows 806 may communicate to a pilot which way to pitch, to recover from an unusual attitude.

FIGS. 13 and 14 illustrate the PFD 200 in the event that the aircraft is pointed nearly straight at the ground or nearly straight into the sky, respectively, such that the horizon line would slide off the PFD and only blue sky or brown ground would be shown. Advantageously, the PFD of the present invention continues to render a sliver of the synthetic texture in the area representing the nearest horizon sky in nose-low attitudes as shown in FIG. 13 and a sliver of the nearest ground in nose high attitudes as shown in FIG. 14.

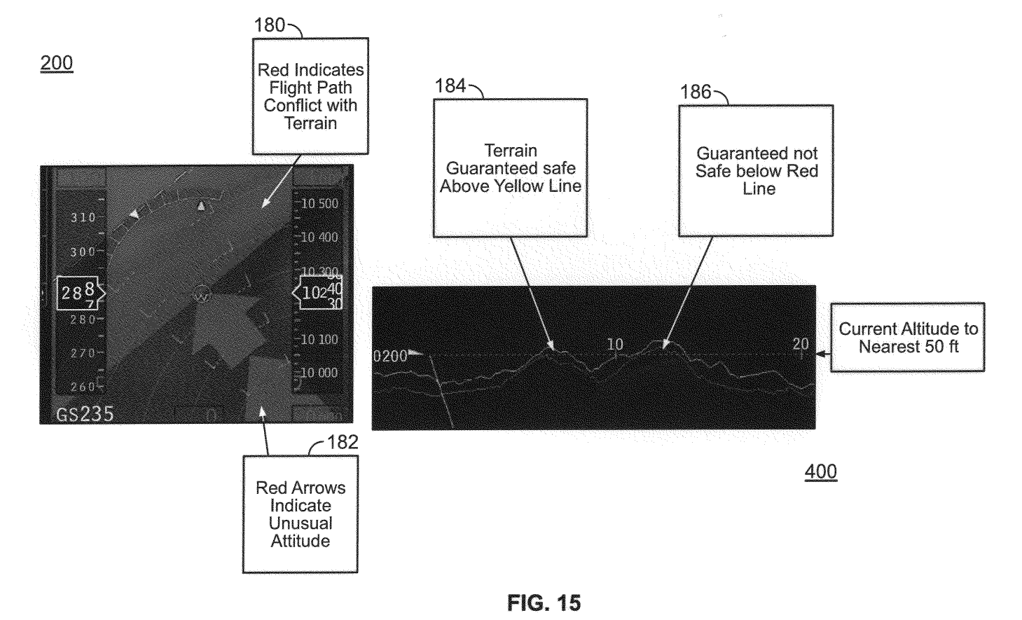

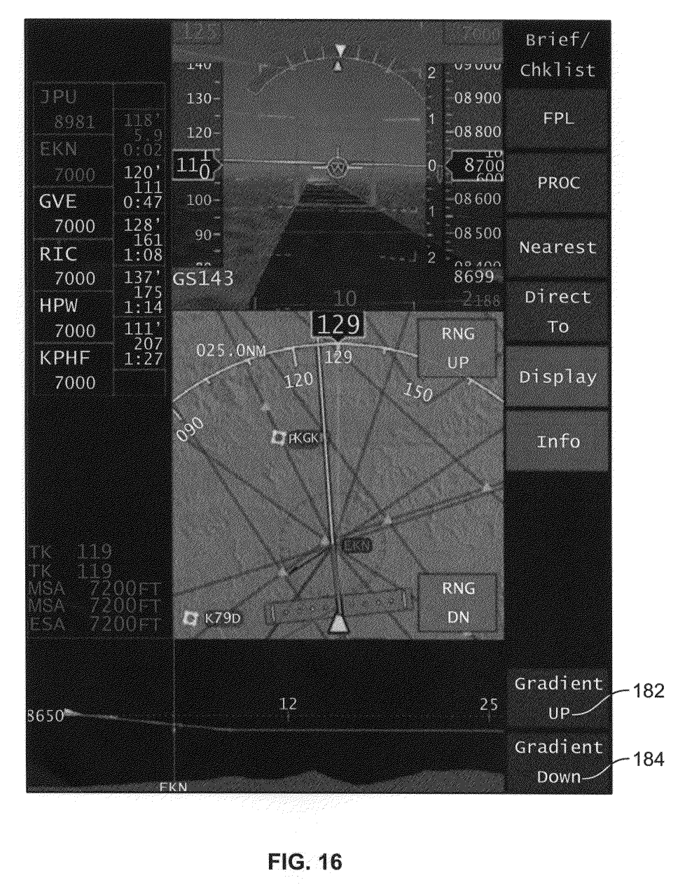

As illustrated in FIG. 15, embodiments of the improved SVS may provide a more robust approach to terrain conflict warning colors than conventional SVS. The improved SVS of the present invention determines the trajectory of the aircraft, and a swath, which is where the aircraft trajectory intersects terrain. Since very distant terrain is not an immediate hazard, the improved SVS suppresses terrain conflicts beyond a selected set point such as 10 miles, although the set point can be changed based on aircraft performance. Embodiments of the improved SVS may color only those areas of terrain in red 180 that are truly in the flight path of the aircraft, although any color is contemplated that communicates terrain or obstacles in the flight path of the aircraft. Thus, it can become very obvious to a pilot, whether or not the aircraft will clear a ridge or area of terrain, as shown in FIG. 15.

The PFD and Vertical Profile Display (“VPD”) can communicate terrain awareness to the pilot, as shown in FIG. 15. The PFD may show red shading in those areas where the aircraft may be in potential conflict with the terrain at some point in time in the future 180. Red arrows 182 may indicate an unusual altitude. Warning colors are used to highlight terrain and obstacles that may be dangerously close to the aircraft's projected flight path. The flight path chosen is a two-step path. The aircraft's path is projected forward sixty seconds into the future. At that point, an immediate climb of five hundred foot per minute is projected. Any terrain or obstacle that is within 500 feet, vertically, of that projected flight path, is highlighted with a red tint, as a warning to the pilot. Such a segmented path is advantageous over the traditional method of resolving a terrain or obstacle conflict by climbing to higher altitudes. Given the poor historical accuracy of ground surveying and aircraft position estimation, terrain warning systems do not support maneuvering or turning to avoid obstacles. The flight path represents the future actions of a pilot who, while descending into hazardous terrain, is alerted to the terrain conflict, and climbs to escape the danger. The sixty seconds of projected descent allows adequate time as a margin for the pilot to initiate a maneuver to escape the potential terrain conflict. The VPD may provide a good estimation of distance required to complete a climb, as well as distance to terrain features in front of the aircraft. Terrain that is guaranteed safe is identified above the yellow line 184 whereas terrain not guaranteed safe is below the red line 186. Red areas in FIG. 15 are highlighted on the PFD when viewed in perspective.

One common problem with SVS that the improved SVS of the present invention has successfully overcome is related to vertical pathway navigation. Simple designs may illustrate the pathway as a fixed, earth-referenced path that climbs from the airport to a designated altitude and then back down to the destination airport. Such a fixed vertical path alignment is problematic in that it is impossible to foresee the climb capability of an aircraft under different conditions such as different winds, temperatures, engine performance, and aircraft loading. Thus, a fixed vertical path may exceed the climb performance of an aircraft, and thereby may cause the pilot to fly into a stall condition by following the pathway. Such a condition is, of course, unsafe. The user changeable climb gradient as illustrated in FIG. 16 seeks to remedy this problem. With this embodiment, the pilot starts from a stored standard climb performance for the selection of the initial climb gradient. A pilot that believes that the gradient is inadequate can increase or decrease the gradient with stepwise increment buttons 182, 184. Since the PFD and VPD may show the change in the gradient, the pilot can use this function very easily to satisfy Air Traffic Control (“ATC”) cross-at altitude clearance limits.

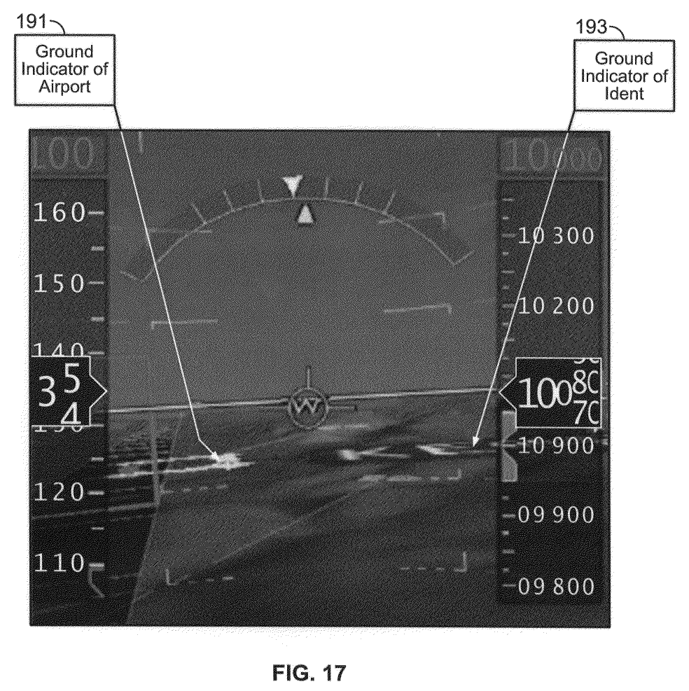

An embodiment of the PFD may illustrate ground indicators as shown in FIG. 17. Ground indicators include airport 191 and identifier (“IDENT”) 193. The airport ground indicator 191 is illustrated as circle-shaped, which is centered on the airport itself. IDENT 193 is the text identifier associated with the airport. For example, Chicago O'Hare is KORD (the “K” is left off when it is implicit that the airport is in the United States, thus leaving ORD).

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. An aircraft guidance system, comprising:
a user interface, wherein said user interface includes a perspective view, a top-down view, and a side-view of terrain and obstacles.

2. An improved synthetic vision system, comprising:
a primary flight display,
a navigation display, and
a vertical profile display, wherein said primary flight display, said navigation display, and said vertical profile display are consolidated on one user interface.

3. The method of claim 2, wherein said user interface is a touch screen.

4. A method for an improved synthetic vision system, comprising:
supplying a touch screen that includes a primary flight display, a navigation display, and a vertical profile display;
selecting an icon representing a function on the touch screen;
inputting a command;
searching a database;
providing a list of results;
choosing a result from said step of providing a list of results;
confirming the result from said step of choosing a result; and
executing the function.

5. A method for data entry on a limited display area, comprising:
providing a semi-transparent telephone key pad style area comprising a plurality of buttons, wherein each of said buttons includes a different number and associated letter to allow entry of alphanumeric data;
entering a waypoint identifier code on the telephone key pad style area;
searching a database for the entered waypoint identifier code;
displaying a list from a plurality of waypoint identifier codes;
selecting a waypoint; and
confirming said selected waypoint.

6. The method of claim 5, wherein said displaying a list from a plurality of waypoint identifier codes further comprises sorting the plurality of waypoint identifier codes from the database.

7. The method of claim 6, wherein said sorting the plurality of waypoint identifier codes further comprises grouping the plurality of waypoint identifier codes by proximity to the position of an aircraft.

8. The method of claim 6, wherein said sorting the plurality of waypoint identifier codes further comprises grouping the plurality of waypoint identifier codes by distance corresponding to said entered waypoint identifier code.

9. The method of claim 6, wherein said sorting the plurality of waypoint identifier codes further comprises grouping the plurality of waypoint identifier codes by the position of a previous selected waypoint identifier code.

10. An improved synthetic vision system to communicate unusual attitudes, comprising:
an attitude symbology wherein an egocentric position of a pilot is inside of a transparent sphere with non-transparent latitude lines for pitch ranging and including 0 degrees (horizon) to 90 degrees up and down.

11. A method for communicating conflict with terrain, comprising:
communicating a flight path trajectory of an aircraft using a standard flight path vector symbol; and
displaying red shading at areas wherein the flight path trajectory intercepts terrain within a predetermined distance.
